(19) United States
(12) Patent Application Publication
(10) Pub. No.: US 2022/0343512 A1
(43) Pub. Date: Oct. 27, 2022

(54) METHOD AND APPARATUS OF PROCESSING IMAGE, ELECTRONIC DEVICE, AND STORAGE MEDIUM

(71) Applicant: BEIJING BAIDU NETCOM SCIENCE TECHNOLOGY CO., LTD., Beijing (CN)

(72) Inventor: Yanru HAO, Beijing (CN)

(73) Assignee: BEIJING BAIDU NETCOM SCIENCE TECHNOLOGY CO., LTD., Beijing (CN)

(21) Appl. No.: 17/858,768

(22) Filed: Jul. 6, 2022

(30) Foreign Application Priority Data
Sep. 29, 2021 (CN) 202111156964.1

(51) Int. Cl. G06T 7/246; G06T 7/187

(52) U.S. Cl. CPC G06T 7/246; G06T 7/187

(57) ABSTRACT

A method of processing an image, which relates to a field of an artificial intelligence technology, in particular to a field of computer vision and deep learning technology, and may be applied to image segmentation or other applications. A solution includes: inputting a to-be-processed image into a first convolution network to obtain a coarse-grained image feature map for the to-be-processed image; inputting the coarse-grained image feature map into a second convolution network to obtain a fine-grained image feature map for the to-be-processed image; and determining an image processing result according to the fine-grained image feature map. There is further provided an apparatus of processing an image, an electronic device, and a storage medium.

This application claims priority of Chinese Patent Application No. 202111156964.1, filed on Sep. 29, 2021, the entire contents of which is incorporated herein in its entirety by reference.

### TECHNICAL FIELD

The present disclosure relates to a field of an artificial intelligence technology, in particular to a field of computer vision and deep learning technology, which may be applied to an image segmentation or other scenes. In particular, the present disclosure relates to a method and an apparatus of processing an image, an electronic device, and a storage medium.

### BACKGROUND

A semantic segmentation refers to identifying a target object and a location of the target object in an image by finding all pixels belonging to the target object. A standard semantic segmentation, also known as a full pixel segmentation, may be implemented to classify each pixel in the image into an object class.

### SUMMARY

In view of this, the present disclosure provides a method and an apparatus of processing an image, an electronic device, and a storage medium.

According to an aspect of the present disclosure, there is provided a method of processing an image, including: inputting a to-be-processed image into a first convolution network to obtain a coarse-grained image feature map for the to-be-processed image; inputting the coarse-grained image feature map into a second convolution network to obtain a fine-grained image feature map for the to-be-processed image; and determining an image processing result according to the fine-grained image feature map.

According to an aspect of the present disclosure, there is provided an apparatus of processing an image, including: a first input module configured to input a to-be-processed image into a first convolution network to obtain a coarse-grained image feature map for the to-be-processed image; a second input module configured to input the coarse-grained image feature map into a second convolution network to obtain a fine-grained image feature map for the to-be-processed image; and an obtaining module configured to determine an image processing result according to the fine-grained image feature map.

According to an aspect of the present disclosure, there is provided an electronic device, including: at least one processor; and a memory communicatively connected to the at least one processor, wherein the memory stores instructions executable by the at least one processor, and the instructions, when executed by the at least one processor, cause the at least one processor to implement the method of processing the image provided by the present disclosure.

According to another aspect of the present disclosure, there is provided a non-transitory computer-readable storage medium having computer instructions stored thereon, wherein the computer instructions allow a computer to implement the method of processing the image provided by the present disclosure.

According to an aspect of the present disclosure, there is provided a computer program product containing a computer program, wherein the computer program, when executed by a processor, is allowed to implement a method of processing the image provided by the present disclosure.

It should be understood that content described in this section is not intended to identify key or important features in embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used to better understand the solution and do not constitute a limitation to the present disclosure.

FIG. 1 shows a flowchart of a method of processing an image according to an embodiment of the present disclosure.

FIG. 2A shows a schematic diagram of a first convolution network according to an embodiment of the present disclosure.

FIG. 2B shows a schematic diagram of a first convolution network according to another embodiment of the present disclosure.

FIG. 3 shows a schematic diagram of a feature extraction sub-network according to an embodiment of the present disclosure.

FIG. 4 shows a schematic diagram of a second convolution network according to an embodiment of the present disclosure.

FIG. 5 shows a schematic diagram of a method of processing an image according to an embodiment of the present disclosure.

FIG. 6 shows a block diagram of an apparatus of processing an image according to an embodiment of the present disclosure.

FIG. 7 shows a block diagram of an electronic device for implementing the method of processing the image according to embodiments of the present disclosure.

### DETAILED DESCRIPTION OF EMBODIMENTS

The following describes exemplary embodiments of the present disclosure with reference to the accompanying drawings, which include various details of embodiments of the present disclosure to facilitate understanding, and should be considered as merely exemplary. Therefore, those of ordinary skilled in the art should realize that various changes and modifications may be made to embodiments described herein without departing from the scope and spirit of the present disclosure. Likewise, for clarity and conciseness, descriptions of well-known functions and structures are omitted in the following description.

A real-time semantic segmentation requires an inference speed of up to 30 fps (frames per second) and a small occupation of memory (e.g. less than 5 MB).

In a related art, a PSPNet (Pyramid Scene Parsing Network) model and a DeepLab model may be used to perform a semantic segmentation to achieve an ideal effect indicator. However, a magnitude of parameters in the PSPNet model and the DeepLab model reaches tens of millions, which may result in the inference speed being less than 1 fps, so that the two models may not be used for a real-time semantic segmentation.

An ENet (Efficient Neural Network) model and an ESPNet (Efficient Spatial Pyramid Neural Network) model may also be used to perform a semantic segmentation to achieve the required inference speed. However, the ENet model and the ESPNet model have a poor segmentation effect.

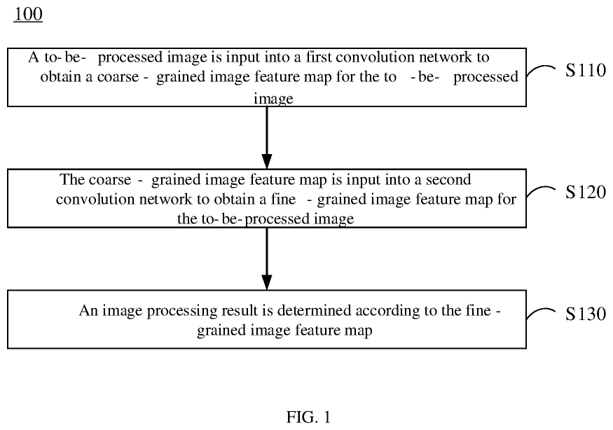

FIG. 1 shows a flowchart of a method of processing an image according to an embodiment of the present disclosure.

As shown in FIG. 1, a method 100 of processing an image may include operations S110 to S130.

In operation S110, a to-be-processed image is input into a first convolution network to obtain a coarse-grained image feature map for the to-be-processed image.

In embodiments of the present disclosure, a 5*5 convolution kernel or a 7*7 convolution kernel may be adopted by the first convolution network.

In embodiments of the present disclosure, the convolution kernel adopted by the first convolution network may be simplified by factorization.

For example, two 3*3 convolution kernels in series may be used instead of the 5*5 convolution kernel to reduce an amount of parameters by 28%. For another example, three 3*3 convolution kernels in series may be used instead of the 7*7 convolution kernel to reduce an amount of parameters by 45%.

In embodiments of the present disclosure, the convolution kernel adopted by the first convolution network may be decomposed into asymmetric convolution kernels.

For example, a 3*3 convolution kernel may be decomposed into a 3*1 convolution kernel and a 1*3 convolution kernel.

For example, in the first convolution network, three 3*3 convolution kernels in series may be used instead of the 7*7 convolution kernel. Then, a 3*1 convolution kernel and a 1*3 convolution kernel in series may be used to replace one or more of the three 3*3 convolution kernels in series. By decomposing a standard convolution kernel into asymmetric convolution kernels, the amount of parameters may be further reduced, and an efficiency of image processing may be improved.

In embodiments of the present disclosure, a skip connection may be performed on a convolution result of each 3*3 convolution kernel, so as to obtain a coarse-grained image feature map.

For example, three 3*3 convolution kernels in series may be used instead of the 7*7 convolution kernel. Then, a 3*1 convolution kernel and a 1*3 convolution kernel in series may be used to replace each of the three 3*3 convolution kernels.

By processing the to-be-processed image using a first 3*1 convolution kernel and a first 1*3 convolution kernel in succession, a first coarse-grained feature map is obtained. By processing the first coarse-grained feature map using a second 3*1 convolution kernel and a second 1*3 convolution kernel in succession, a second coarse-grained feature map is obtained. By processing the second coarse-grained feature map using a third 3*1 convolution kernel and a third 1*3 convolution kernel, a third coarse-grained feature map is obtained. The first coarse-grained feature map, the second coarse-grained feature map and the third coarse-grained feature map may be merged (such as stitched or summed) to obtain a coarse-grained image feature map. A plurality of coarse-grained feature maps may be merged by means of skip connection, so that a multi-scale feature mapping may be obtained.

In embodiments of the present disclosure, a down-sampling may be performed on the coarse-grained image feature map.

For example, a max pooling operation may be performed on the coarse-grained image feature map, so as to perform a down-sampling and obtain a down-sampled coarse-grained image feature map. The down-sampling may further compress the feature map and reduce the amount of parameters.

In operation S120, the coarse-grained image feature map is input into a second convolution network to obtain a fine-grained image feature map for the to-be-processed image.

In embodiments of the present disclosure, the second convolution network includes a plurality of feature extraction sub-networks concatenated, and each feature extraction sub-network is used to successively extract an image feature with a respective granularity.

In an example of the present disclosure, each feature extraction sub-network may include K processing modules, and each processing module is used to perform a dilated convolution on an image feature map by using a standard convolution kernel.

For example, each processing module is used to perform a dilated convolution on the image feature map by using a 3*3 dilated convolution kernel. The amount of parameters may be further reduced by performing the dilated convolution on the image feature map.

In embodiments of the present disclosure, each feature extraction sub-network may include K processing modules, and each processing module is used to perform a dilated convolution on an image feature map by using an asymmetric convolution kernel.

For example, a processing module may perform a dilated convolution on the image feature map by using a 3*1 convolution kernel and a 1*3 convolution kernel in series.

In embodiments of the present disclosure, a k^{th} processing module in the K processing modules may have a dilation rate of m/2ⁿ, where m is an even number greater than or equal to 2, k=1, 2, . . . K, n=K−1, . . . 2, 1, 0, and the dilation rate=1 when m/2ⁿ is less than 1.

For example, if m=2 and K=4, then n=3, 2, 1, 0, and the dilation rates of the K processing modules are 1, 1, 1 and 2, respectively. For another example, if m=16 and K=4, then n=3, 2, 1, 0, and the dilation rates of the K processing modules are 2, 4, 8 and 16, respectively. For another example, if m=16 and K=5, then n=4, 3, 2, 1, 0, and the dilation rates of the K processing modules are 1, 2, 4, 8 and 16, respectively. By setting the dilation rate of the K processing modules to m/2ⁿ, features at different granularity may be extracted, which may ensure that the features are not redundant or dismissed.

In embodiments of the present disclosure, the image feature map may be input into the K processing modules in parallel to obtain K feature maps.

For example, the image feature map may be a coarse-grained image feature map or a down-sampled coarse-grained image feature map. For another example, the image feature map may also be an output of a previous feature extraction sub-network.

In embodiments of the present disclosure, the K feature maps may be summed to obtain a merged feature map as an output of each feature extraction sub-network.

For example, when m=16 and K=5, n=4, 3, 2, 1, 0, then the dilation rates of the K processing modules are 1, 2, 4, 8 and 16, respectively, and five feature maps may be obtained. In an example, a first feature map and a second feature map may be added to obtain a first merged feature sub-map. The first merged feature sub-map and a third feature map may be added to obtain a second merged feature sub-map. The second merged feature sub-map and a fourth feature map may be added to obtain a third merged feature sub-map. The third merged feature sub-map and a fifth feature map may be added to obtain a fourth merged feature sub-map. Then, the first feature map, the first merged feature sub-map, the second merged feature sub-map, the third merged feature sub-map and the fourth merged feature sub-map may be added to obtain the merged feature map.

In embodiments of the present disclosure, a value of m increases successively in the plurality of feature extraction sub-networks concatenated.

For example, there may be four feature extraction sub-networks concatenated, and the value of m is 2, 4, 8 and 16 in succession.

In embodiments of the present disclosure, in l feature extraction sub-networks concatenated, the value of m in an i^{th} feature extraction network is less than the value of m in an i+2th feature extraction network, and the value of m in the i^{th} feature extraction network is equal to the value of m in an i+1^{th} feature extraction network, where l is an even number, l≥4, and i is an odd number, i=1, . . . , l−1.

For example, in eight feature extraction sub-networks concatenated, m=2 in a first feature extraction sub-network and a second feature extraction sub-network; m=4 in a third feature extraction sub-network and a fourth feature extraction sub-network; m=8 in a fifth feature extraction sub-network and a sixth feature extraction sub-network; m=16 in a seventh feature extraction sub-network and an eighth feature extraction sub-network. By using the feature extraction sub-networks with the same m value to perform two operations in series each time, a fine-grained feature may be better extracted. Those skilled in the art may understand that three or more operations may be performed in series according to an actual application scenario, as long as features of various scales may be fully extracted.

In embodiments of the present disclosure, a down-sampling may be performed on the output of the feature extraction sub-network.

For example, the down-sampling may be performed on the output of one or more of the plurality of feature extraction sub-networks concatenated. Similarly, the down-sampling may be performed by using a max pooling operation or other methods. With the down-sampling, the feature map may be further compressed and the amount of parameters may be reduced. Those skilled in the art may understand that the down-sampling operation may be performed using various methods, not limited to a max pooling operation.

In embodiments of the present disclosure, a down-sampling may be performed on one or more of the K feature maps.

In operation S130, an image processing result is determined according to the fine-grained image feature map.

In embodiments of the present disclosure, the fine-grained image feature map is excited to obtain an excitation feature map.

For example, the fine-grained image feature map may be processed using a 1*1 convolution kernel to obtain a convoluted fine-grained image feature map. Then, the convoluted fine-grained image feature map may be processed using a PReLU (Parametric Rectified Linear Unit) excitation function to obtain the excitation feature map. Since the first convolution network and the second convolution network are shallow networks, a better excitation effect may be achieved by using the PReLU excitation function.

In embodiments of the present disclosure, a segmentation mask for the to-be-processed image may be obtained according to the excitation feature map.

For example, an up-sampling (e.g., a linear interpolation) may be performed on the excitation feature map. Then, the up-sampled excitation feature map is input into a binary classifier to obtain the segmentation mask. Those skilled in the art may understand that the up-sampling operation may be performed using various methods, not limited to the linear interpolation.

In embodiments of the present disclosure, the image processing result may be obtained using the segmentation mask.

For example, the segmentation mask may be directly used as the image processing result.

Through embodiments of the present disclosure, the amount of parameters in a process of image segmentation may be reduced by replacing the standard convolution kernel with an asymmetric convolution kernel and using the dilation convolution technology. A multi-scale multi-granularity feature mapping may be obtained by merging the outputs of a plurality of convolution layers in the first convolution network and processing the image feature map using a plurality of feature extraction sub-networks concatenated, so that an effect of image segmentation may be ensured. In this way, a balance between the effect and the memory occupation of the real-time semantic segmentation may be achieved, so that the semantic segmentation may be applied to a terminal and the application scenario of the semantic segmentation is expanded.

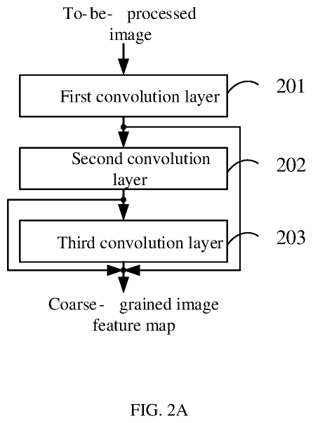

FIG. 2A shows a schematic diagram of the first convolution network according to an embodiment of the present disclosure.

As shown in FIG. 2A, the first convolution network includes a first convolution layer 201, a second convolution layer 202 and a third convolution layer 203.

The first convolution layer 201, the second convolution layer 202 and the third convolution layer 203 may use a standard convolution kernel (e.g., a 3*3 convolution kernel) or an asymmetric convolution kernel.

For example, in the first convolution layer 201, a 3*3 convolution kernel is used, and a stride is 2. In the second convolution layer 202, a 3*3 convolution kernel is used, and a stride is 1. In the third convolution layer 203, a 3*3 convolution kernel is used, and a stride is 1.

With a 32-dimensional to-be-processed image as an input, the first convolution layer 201 may output a 32-dimensional first coarse-grained feature map. With the first coarse-grained feature map as an input, the second convolution layer 202 may output a 32-dimensional second coarse-grained feature map. With the second coarse-grained feature map as an input, the third convolution layer 203 may output a 32-dimensional third coarse-grained feature map. The first coarse-grained feature map, the second coarse-grained feature map and the third coarse-grained feature map may be added to obtain a 32-dimensional coarse-grained image feature map.

FIG. 2B shows an example schematic diagram of the first convolution network according to another embodiment of the present disclosure.

As shown in FIG. 2B, the first convolution layer 201 includes a first asymmetric convolution layer 2011 and a second asymmetric convolution layer 2012. The second convolution layer 202 includes a third asymmetric convolution layer 2021 and a fourth asymmetric convolution layer 2022. The third convolution layer 203 includes a fifth asymmetric convolution layer 2031 and a sixth asymmetric convolution layer 2032.

The first asymmetric convolution layer 2011, the third asymmetric convolution layer 2021 and the fifth asymmetric convolution layer 2031 may contain an asymmetric convolution kernel (e.g., a 3*1 convolution kernel) respectively. The second asymmetric convolution layer 2012, the fourth asymmetric convolution layer 2022 and the sixth asymmetric convolution layer 2032 may contain another asymmetric convolution kernel (e.g., a 1*3 convolution kernel) respectively.

As shown in FIG. 2B, the first asymmetric convolution layer 2011 and the second asymmetric convolution layer 2012 are concatenated in series.

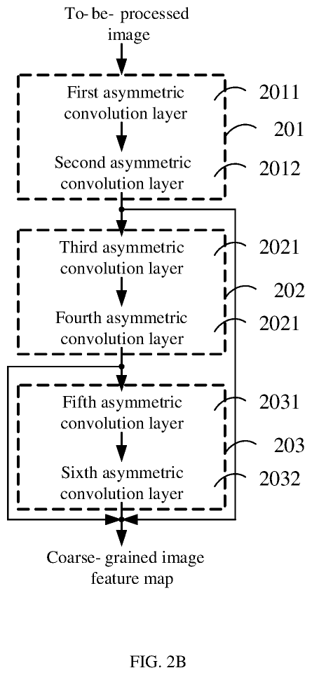

FIG. 3 shows a schematic diagram of a feature extraction sub-network according to an embodiment of the present disclosure.

As shown in FIG. 3, in the feature extraction sub-network, k=5, m=16.

In the feature extraction sub-network, a first processing module 301 has a dilation rate of 1, a second processing module 302 has a dilation rate of 2, a third processing module 303 has a dilation rate of 4, a fourth processing module 304 has a dilation rate of 8, and a fifth processing module 305 has a dilation rate of 16. For example, a dilation convolution kernel of any processing module may be decomposed into asymmetric dilation convolution kernels.

The first feature extraction sub-network further includes a first merging sub-module 306, a second merging sub-module 307, a third merging sub-module 308, a fourth merging sub-module 309, and a merging module 310.

The first merging sub-module 306 may add a first feature map output by the first processing module 301 and a second feature map output by the second processing module 302 and output a first merged feature sub-map. The second merging sub-module 307 may add the first merged feature sub-map and a third feature map output by the third processing module 303 and output a second merged feature sub-map. The third merging sub-module 308 may add the second merged feature sub-map and a fourth feature map output by the fourth processing module 304 and output a third merged feature sub-map. The fourth merging sub-module 309 may add the third merged feature sub-map and a fifth feature map output by the fifth processing module 305 and output a fourth merged feature sub-map. The merging module 310 may add the first feature map, the first merged feature sub-map, the second merged feature sub-map, the third merged feature sub-map and the fourth merged feature sub-map and output a merged feature map.

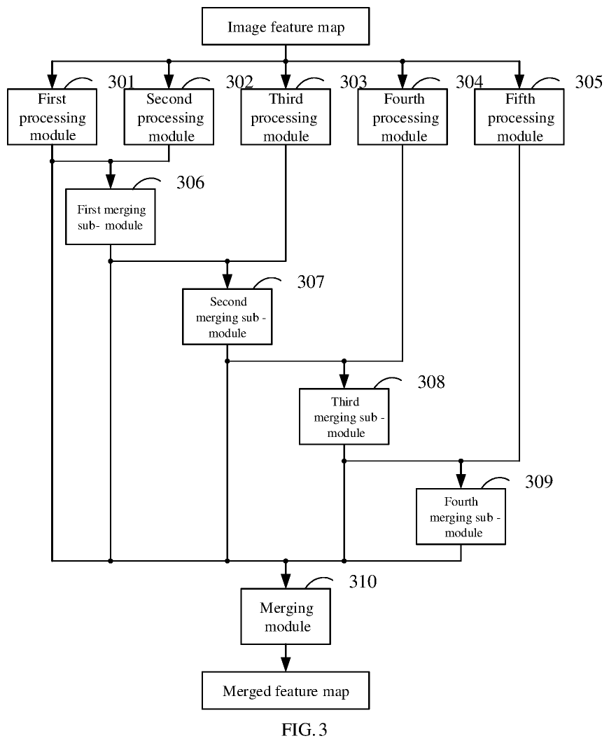

FIG. 4 shows a schematic diagram of the second convolution network according to an embodiment of the present disclosure.

As shown in FIG. 4, the second convolution network may include eight feature extraction sub-networks concatenated. With an image feature map as an input, a first feature extraction sub-network 401 may output a merged feature map. The image feature map may be, for example, the coarse-grained image feature map output by the first convolution network in FIG. 2A or FIG. 2B.

In the eight feature extraction sub-networks concatenated, m=2 in a first feature extraction sub-network 401 and a second feature extraction sub-network 402; m=4 in a third feature extraction sub-network 403 and a fourth feature extraction sub-network 404; m=8 in a fifth feature extraction sub-network 405 and a sixth feature extraction sub-network 406; m=16 in a seventh feature extraction sub-network 407 and an eighth feature extraction sub-network 408.

In embodiments, a down-sampling layer may be added between the eight feature extraction sub-networks concatenated.

For example, a first down-sampling layer may be added before the first feature extraction sub-network. The first down-sampling layer may, for example, with the 32-dimensional coarse-grained image feature map in FIG. 2A as an input, output a 64-dimensional down-sampled coarse-grained image feature map. In the first down-sampling layer, a 3*3 convolution kernel may be firstly used to perform a convolution operation (with a stride of 2) on the 32-dimensional coarse-grained image feature map, and then a 2*2 convolution kernel may be used to perform a max pooling operation (with a stride of 1) to obtain a 64-dimensional down-sampled coarse-grained image feature map.

With the 64-dimensional down-sampled coarse-grained image feature map as an input, the first feature extraction sub-network 401 may output a first merged feature map. With the first merged feature map as an input, the second feature extraction sub-network 402 may output a 64-dimensional second merged feature map.

A second down-sampling layer may be added between the second feature extraction sub-network 402 and the third feature extraction sub-network 403. With the 64-dimensional second merged feature map as an input, the second down-sampling layer may output a down-sampled second merged feature map. In the second down-sampling layer, a 3*3 convolution kernel may be firstly used to perform a convolution operation (with a stride of 2) on the 64-dimensional second merged feature map, and then a 2*2 convolution kernel may be used to perform a max pooling operation (with a stride of 1) to obtain a 128-dimensional down-sampled second merged feature map.

With the 128-dimensional down-sampled second merged feature map as an input, the third feature extraction sub-network 403 may output a third merged feature map. With the third merged feature map as an input, the fourth feature extraction sub-network 404 may output a 128-dimensional fourth merged feature map.

With the 128-dimensional fourth merged feature map as an input, the fifth feature extraction sub-network 405 may output a fifth merged feature map. With the fifth merged feature map as an input, the sixth feature extraction sub-network 406 may output a 128-dimensional sixth merged feature map. With the sixth merged feature map as an input, the seventh feature extraction sub-network 407 may output a seventh merged feature map. With the seventh merged feature map as an input, the eighth feature extraction sub-network 408 may output a 128-dimensional fine-grained image feature map.

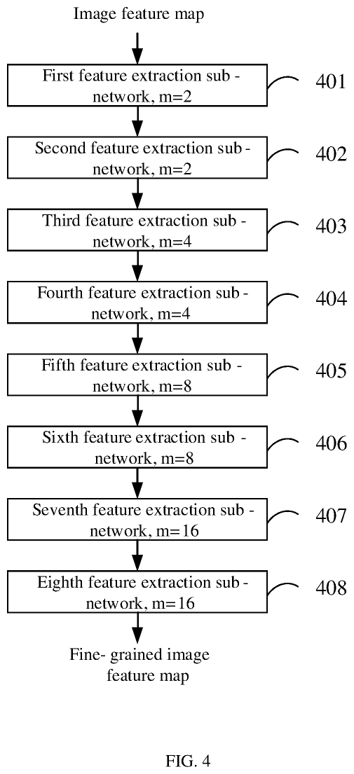

FIG. 5 shows a schematic diagram of a method of processing an image according to an embodiment of the present disclosure.

As shown in FIG. 5, with a to-be-processed image as an input, a first convolution network 501 may output a coarse-grained image feature map. The first convolution network may be, for example, the first convolution network in FIG. 2A or FIG. 2B.

With the coarse-grained image feature map as an input, a second convolution network 502 may output a fine-grained image feature map. The second convolution network 502 may be, for example, the second convolution network in FIG. 4 and include, for example, a plurality of feature extraction sub-networks concatenated as shown in FIG. 3.

An image processing results may be obtained according to the fine-grained image feature map.

For example, the 128-dimensional fine-grained image feature map in FIG. 4 may be input into an excitation layer to obtain a 32-dimensional excitation feature map. In the excitation layer, a 1*1 convolution kernel may be used to perform a convolution operation (with a stride of 1) on the fine-grained image feature map to obtain a convoluted fine-grained image feature map. Then, a PReLU excitation function is used to excite the convoluted fine-grained image feature map to obtain the excitation feature map.

The 32-dimensional excitation feature map may be then input into an up-sampling layer to obtain a 32-dimensional up-sampled excitation feature map. Then the 32-dimensional up-sampled excitation feature map is input into a binary classifier to obtain a segmentation mask. The segmentation mask may be used to obtain the image processing result.

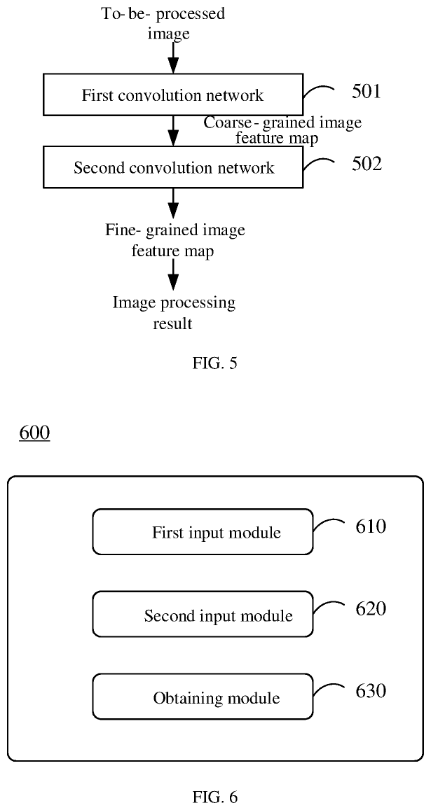

According to the method of processing the image provided by the present disclosure, the present disclosure further provides an apparatus of processing an image, which will be described in detail below with reference to FIG. 6.

FIG. 6 shows a block diagram of an apparatus of processing an image according to an embodiment of the present disclosure.

As shown in FIG. 6, an apparatus 600 of processing an image includes a first input module 610, a second input module 620, and an obtaining module 630.

The first input module 610 is used to input a to-be-processed image into a first convolution network to obtain a coarse-grained image feature map for the to-be-processed image.

The second input module 620 is used to input the coarse-grained image feature map into a second convolution network to obtain a fine-grained image feature map for the to-be-processed image.

The obtaining module 630 may obtain an image processing result according to the fine-grained image feature map.

In embodiments, the second convolution network includes a plurality of feature extraction sub-networks concatenated, and each feature extraction sub-network is used to successively extract an image feature with a respective granularity.

In embodiments, each feature extraction sub-network includes K processing modules, and each processing module is used to perform a dilated convolution on an image feature map by using an asymmetric convolution kernel. The second input module includes: a parallel input unit used to input an image feature map into the K processing modules in parallel to obtain K feature maps; and a merging unit used to sum the K feature maps to obtain a merged feature map as an output of the feature extraction sub-network.

In embodiments, a k^{th} processing module in the K processing modules has a dilation rate of m/2ⁿ, where m is an even number greater than or equal to 2, k=1, 2, . . . K, n=K−1, . . . 2, 1, 0, and the dilation rate=1 when m/2ⁿ is less than 1.

In embodiments, a value of m increases successively in the plurality of feature extraction sub-networks concatenated.

In embodiments, the apparatus 600 of processing the image further includes a down-sampling module used to perform a down-sampling on the image feature map.

In embodiments, the obtaining module includes: an excitation unit used to excite the fine-grained image feature map to obtain an excitation feature map; a first obtaining unit used to determine a segmentation mask for the to-be-processed image according to the excitation feature map; and a second obtaining unit used to determine the image processing result by using the segmentation mask.

It should be noted that in the technical solution of the present disclosure, an acquisition, a storage, a use, a processing, a transmission, a provision and a disclosure of a user personal information involved comply with provisions of relevant laws and regulations, and do not violate public order and good custom.

According to embodiments of the present disclosure, the present disclosure further provides an electronic device, a readable storage medium, and a computer program product.

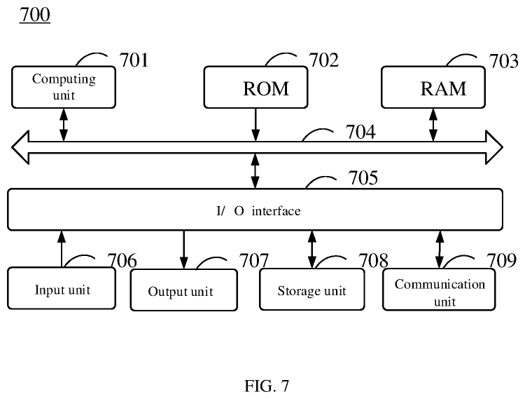

FIG. 7 shows a schematic block diagram of an exemplary electronic device 700 for implementing the method of processing the image in embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 7, the device 700 includes a computing unit 701 which may perform various appropriate actions and processes according to a computer program stored in a read only memory (ROM) 702 or a computer program loaded from a storage unit 708 into a random access memory (RAM) 703. In the RAM 703, various programs and data necessary for an operation of the device 700 may also be stored. The computing unit 701, the ROM 702 and the RAM 703 are connected to each other through a bus 704. An input/output (I/O) interface 705 is also connected to the bus 704.

A plurality of components in the device 700 are connected to the I/O interface 705, including: an input unit 706, such as a keyboard, or a mouse; an output unit 707, such as displays or speakers of various types; a storage unit 708, such as a disk, or an optical disc; and a communication unit 709, such as a network card, a modem, or a wireless communication transceiver. The communication unit 709 allows the device 700 to exchange information/data with other devices through a computer network such as Internet and/or various telecommunication networks.

The computing unit 701 may be various general-purpose and/or a dedicated processing assemblies having processing and computing capabilities. Some examples of the computing unit 701 include, but are not limited to, a central processing unit (CPU), a graphics processing unit (GPU), various dedicated artificial intelligence (AI) computing chips, various computing units that run machine learning model algorithms, a digital signal processing processor (DSP), and any suitable processor, controller, microcontroller, etc. The computing unit 701 executes various methods and processing described above, such as the method of processing the image. For example, in embodiments, the method of processing the image may be implemented as a computer software program which is tangibly embodied in a machine-readable medium, such as the storage unit 708. In embodiments, the computer program may be partially or entirely loaded and/or installed in the device 700 via the ROM 702 and/or the communication unit 709. The computer program, when loaded in the RAM 703 and executed by the computing unit 701, may execute one or more steps in the method of processing the image described above. Alternatively, in other embodiments, the computing unit 701 may be configured to execute the method of processing the image by any other suitable means (e.g., by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a load programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from a storage system, at least one input device and at least one output device, and may transmit the data and instructions to the storage system, the at least one input device, and the at least one output device.

Program codes for implementing the methods of the present disclosure may be written in one programming language or any combination of more programming languages. These program codes may be provided to a processor or controller of a general-purpose computer, a dedicated computer or other programmable data processing apparatus, such that the program codes, when executed by the processor or controller, cause the functions/operations specified in the flowcharts and/or block diagrams to be implemented. The program codes may be executed entirely on a machine, partially on a machine, partially on a machine and partially on a remote machine as a stand-alone software package or entirely on a remote machine or server.

In the context of the present disclosure, a machine-readable medium may be a tangible medium that may contain or store a program for use by or in connection with an instruction execution system, an apparatus or a device. The machine-readable medium may be a machine-readable signal medium or a machine-readable storage medium. The machine-readable medium may include, but is not limited to, an electronic, a magnetic, an optical, an electromagnetic, an infrared, or a semiconductor system, apparatus, or device, or any suitable combination of the above. More specific examples of the machine-readable storage medium may include an electrical connection based on one or more wires, a portable computer disk, a hard disk, a random access memory (RAM), a read only memory (ROM), an erasable programmable read only memory (EPROM or a flash memory), an optical fiber, a compact disk read only memory (CD-ROM), an optical storage device, a magnetic storage device, or any suitable combination of the above.

In order to provide interaction with the user, the systems and technologies described here may be implemented on a computer including a display device (for example, a CRT (cathode ray tube) or LCD (liquid crystal display) monitor) for displaying information to the user, and a keyboard and a pointing device (for example, a mouse or a trackball) through which the user may provide the input to the computer. Other types of devices may also be used to provide interaction with users. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and the Internet.

The computer system may include a client and a server. The client and the server are generally far away from each other and usually interact through a communication network. The relationship between the client and the server is generated through computer programs running on the corresponding computers and having a client-server relationship with each other. The server may be a cloud server, also known as a cloud computing server or a cloud host, which is a host product in a cloud computing service system to overcome the defects of difficult management and weak business expansion in traditional physical hosts and VPS (“Virtual Private Server”, or “VPS” for short) services. The server may also be a server of a distributed system, or a server combined with a blockchain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A method of processing an image, the method comprising:
inputting a to-be-processed image into a first convolution network to obtain a coarse-grained image feature map for the to-be-processed image;
inputting the coarse-grained image feature map into a second convolution network to obtain a fine-grained image feature map for the to-be-processed image; and
determining an image processing result according to the fine-grained image feature map.

2. The method of claim 1, wherein the second convolution network comprises a plurality of feature extraction sub-networks concatenated, and each feature extraction sub-network is configured to successively extract an image feature with a respective granularity.

3. The method of claim 2, wherein each feature extraction sub-network comprises K processing modules, and each processing module is configured to perform a dilated convolution on an image feature map by using an asymmetric convolution kernel; and
wherein the inputting the coarse-grained image feature map into a second convolution network to obtain a fine-grained image feature map for the to-be-processed image comprises:
inputting an image feature map into the K processing modules in parallel to obtain K feature maps; and
summing the K feature maps to obtain a merged feature map as an output.

4. The method of claim 3, wherein a k^{th} processing module in the K processing modules has a dilation rate of m/2ⁿ, where m is an even number greater than or equal to 2, k=1, 2, . . . K, n=K−1, . . . 2, 1, 0, and the dilation rate=1 when m/2ⁿ is less than 1.

5. The method of claim 4, wherein a value of m increases successively in the plurality of feature extraction sub-networks concatenated.

6. The method of claim 3, further comprising performing a down-sampling on the image feature map.

7. The method of claim 1, wherein the determining an image processing result based on the fine-grained image feature map comprises:
exciting the fine-grained image feature map to obtain an excitation feature map;
determining a segmentation mask for the to-be-processed image according to the excitation feature map; and
determining the image processing result by using the segmentation mask.

8. An electronic device, comprising:
at least one processor; and
a memory communicatively connected to the at least one processor, wherein the memory stores instructions executable by the at least one processor, and the instructions, when executed by the at least one processor, are configured to cause the at least one processor to at least:
input a to-be-processed image into a first convolution network to obtain a coarse-grained image feature map for the to-be-processed image;
input the coarse-grained image feature map into a second convolution network to obtain a fine-grained image feature map for the to-be-processed image; and
determine an image processing result according to the fine-grained image feature map.

9. The electronic device of claim 8, wherein the second convolution network comprises a plurality of feature extraction sub-networks concatenated, and each feature extraction sub-network is configured to successively extract an image feature with a respective granularity.

10. The electronic device of claim 9, wherein each feature extraction sub-network comprises K processing modules, and each processing module is configured to perform a dilated convolution on an image feature map by using an asymmetric convolution kernel; and
wherein the instructions, when executed by the at least one processor, are further configured to cause the at least one processor to:
input an image feature map into the K processing modules in parallel to obtain K feature maps; and
sum the K feature maps to obtain a merged feature map as an output.

11. The electronic device of claim 10, wherein a k^{th} processing module in the K processing modules has a dilation rate of m/2ⁿ, where m is an even number greater than or equal to 2, k=1, 2, . . . K, n=K−1, . . . 2, 1, 0, and the dilation rate=1 when m/2ⁿ is less than 1.

12. The electronic device of claim 11, wherein a value of m increases successively in the plurality of feature extraction sub-networks concatenated.

13. The electronic device of claim 10, wherein the instructions, when executed by the at least one processor, are further configured to cause the at least one processor to perform a down-sampling on the image feature map.

14. The electronic device of claim 8, wherein the instructions, when executed by the at least one processor, are further configured to cause the at least one processor to:
excite the fine-grained image feature map to obtain an excitation feature map;
determine a segmentation mask for the to-be-processed image according to the excitation feature map; and
determine the image processing result by using the segmentation mask.

15. A non-transitory computer-readable storage medium having computer instructions therein, the computer instructions, when executed by a computer system, configured to cause the computer system to at least:
input a to-be-processed image into a first convolution network to obtain a coarse-grained image feature map for the to-be-processed image;
input the coarse-grained image feature map into a second convolution network to obtain a fine-grained image feature map for the to-be-processed image; and
determine an image processing result according to the fine-grained image feature map.

16. The non-transitory computer-readable storage medium of claim 15, wherein the second convolution network comprises a plurality of feature extraction sub-networks concatenated, and each feature extraction sub-network is configured to successively extract an image feature with a respective granularity.

17. The non-transitory computer-readable storage medium of claim 16, wherein each feature extraction sub-network comprises K processing modules, and each processing module is configured to perform a dilated convolution on an image feature map by using an asymmetric convolution kernel; and
wherein the computer instructions are further configured to cause the computer system to:
input an image feature map into the K processing modules in parallel to obtain K feature maps; and
sum the K feature maps to obtain a merged feature map as an output.

18. The non-transitory computer-readable storage medium of claim 17, wherein a k^{th} processing module in the K processing modules has a dilation rate of m/2ⁿ, where m is an even number greater than or equal to 2, k=1, 2, . . . K, n=K−1, . . . 2, 1, 0, and the dilation rate=1 when m/2ⁿ is less than 1.

19. The non-transitory computer-readable storage medium of claim 18, wherein a value of m increases successively in the plurality of feature extraction sub-networks concatenated.

20. The non-transitory computer-readable storage medium of claim 15, wherein the computer instructions are further configured to cause the computer system to:
excite the fine-grained image feature map to obtain an excitation feature map;
determine a segmentation mask for the to-be-processed image according to the excitation feature map; and
determine the image processing result by using the segmentation mask.
